(19) United States
(12) Patent Application Publication
(10) Pub. No.: US 2024/0369297 A1
(43) Pub. Date: Nov. 7, 2024

(54) Spray stack

(71) Applicant: Daniel Flaherty, Coon Rapids, MN (US)

(72) Inventor: Daniel Flaherty, Coon Rapids, MN (US)

(21) Appl. No.: 18/445,064

(22) Filed: Mar. 28, 2023

(51) Int. Cl. F26B 9/00; A47B 87/02; F26B 9/10

(52) U.S. Cl. CPC F26B 9/003; A47B 87/0207; F26B 9/10

(57) ABSTRACT

The Spray Stack is a portable drying rack for objects that have been painted, stained, or otherwise finished and need to be dried or stored until use. The Spray Stack has a set of interlocking arms that are notched and connect at two points along each arm. Arms stack together in a cross hatched manner in sets of two. These arms are stacked and interlocked with identically structured arms laying perpendicular and across them creating a three-dimensional shape similar to a number sign (#) when seen from above. The arms are slightly angled up at the end to an approximate five-degree pitch. The arm assembly is stacked upon a wheeled base that folds in half for easy storage and portability. The assembly of the arms and their stacking onto the unfolded base can be done without any tools and in a confined area.

### REFERENCE OF ANY PRIOR APPLICATION

A provisional patent for the Spray Stack was filed with the USPTO, application No.: 62/922,690, filing date of Aug. 23, 2019. A patent application for the Spray Stack was filed on Aug. 20, 2020 as application Ser. No. 16/999,255. This patent application is filed as a “Continuation in Part” application regarding and with reference to that application Ser. No. 16/999,255, and is filed under 37 CFR Section 153 (b).

### BACKGROUND AND CIRCUMSTANCES OF THE INVENTION

Daniel Flaherty, the inventor, has worked in the finishing area of the residential construction and remodeling industry for over 40 years. One typical manner of drying recently finished objects, such as cabinetry, is to paint, stain or otherwise finish the objects at the “paint shop” of the contractor and then after fully drying on racks, transport the objects to the construction site. Space needs to be dedicated to the racks in the shop. The racks are not adaptable to an ever-changing number of drying items. The fully dried items need to be transported to the site without damaging or marring the finishing work. Travel time accrues. Transport damage happens. The other current method is to finish the items on the job-site and then use whatever improvised method is available to dry them: laying them against a wall; stacking them on 2 by 4's laying on buckets; laying them on a table with a drop-cloth. Also, often the on-site environment is not sufficiently clean and these methods usually take a lot of space.

None of these methods preserves the integrity of the finished product. Mr. Flaherty would often finish items in his garage so he could ensure the quality of the final product.

Mr. Flaherty often wondered if somehow the finishing and drying could be done “on site” and not at the contractor's shop without sacrificing quality. If so, he thought a portable rack could ensure quality, efficiency and integrity of the finished product. He researched do-it-yourself type racks and looked at adapting various rack designs with the goal of making a rack that is portable and easy to assemble and disassemble. His goal was to design a rack that would be portable so workers could move site to site and not back and forth to and from the shop. The rack also needed to be easily assembled, so the workers would not spend the time they save working on-site merely assembling the rack.

The Spray Stack (including its base) is easily portable because its components can fit in a bag the size of a softball bat bag. It can be assembled in a matter of two or three minutes with no tools. (The initial assembly of the base requires basic tools to affix its hinges). It saves time. It eliminates potential transport damage from shop to site. It allows finishing crews to move from site to site, and not from shop to site, and back to the shop. Its portability and small size allow it to be placed in a clean on-site environment, like a small room or closet, ensuring a clean drying space. And, its size can be modified to fit the particulars of a drying job.

### SUMMARY OF THE INVENTION

Spray Stack is a drying rack of multiple, notched, interlocking stacking arms which, when assembled attach to a wheeled base which folds. The rack's assembly does not require tools and the rack's mounting onto the base does not require tools either. The base itself requires initial easy attachment of hinges, which can be done with basic tools. The rack provides construction industry finishing professionals (“finishers”) a portable, easily assembled, and disassembled, drying rack which can be used on-site.

Currently, larger contractors finish and dry their items at the shop on large, immobile drying racks. Smaller contractors or finishers are forced to finish and dry items on site: by laying them against a wall, on top of 2 by 4's mounted on buckets, or some other improvised method. Often the environment is not clean and the integrity of the finish job is damaged. Often there is not ample space to properly dry items.

The Spray Stack allows finishers to transport the Spray Stack rack in a bag about the size of a softball bat bag to the job site, assemble the rack and affix it to the base in a couple of minutes, dry the items on site, disassemble it with ease and move on to the next finishing job site. It saves time, it provides for transport damage avoidance, it is relatively lightweight, and assembles and disassembles without tools. It improves quality, efficiency and the integrity of the finished product. It can fit in a closet. It is a time and money saver for the finishing industry.

### BRIEF DESCRIPTION OF THE SEVERAL VIEWS OF THE DRAWINGS

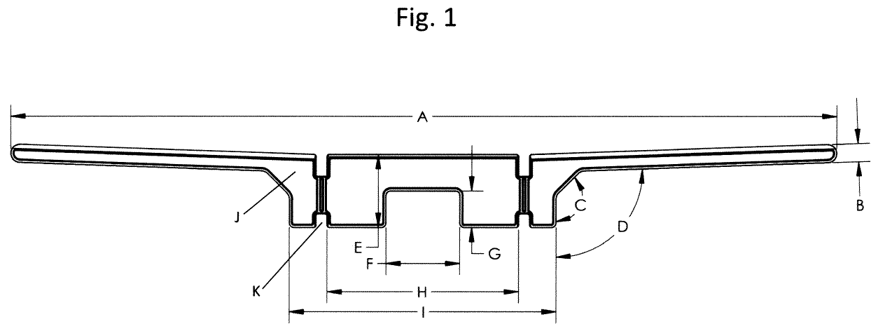

FIG. 1 Is a mechanical drawing of a straight-on view of the “arm”, multiple identical numbers of which are stacked upon each other. The stacked assembly is then attached to the base.
A is 45 inches;
B is 2×1.0 inches;
C is 2×135 degrees;
D is 2×92 degrees;
E is 4.0 inches;
F is 4 inches;
G is 2 inches;
H is 2×10.41 inches;
I is 14.5 inches;
J is Arm
K is Notch

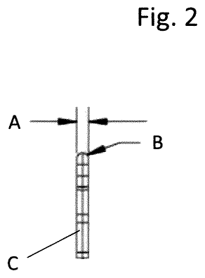

FIG. 2 Is a mechanical drawing of a side view of the arm.
A is 0.50 inches;
B is R.25 inches (both sides and both ends);
C is Arm;

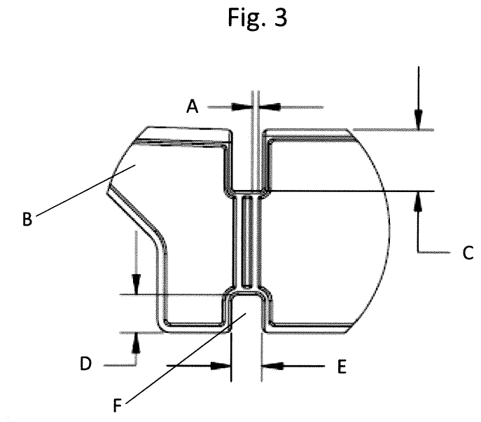

FIG. 3 Is a mechanical drawing of a view of an arm's notched area where the arms stack upon one and other;
A is 8×0.125 inches;
B is Arm;
C is 2×1.2 inches;
D is 2×0.75 inches+ or −0.10
E is 4×0.6 inches;
F Notch;

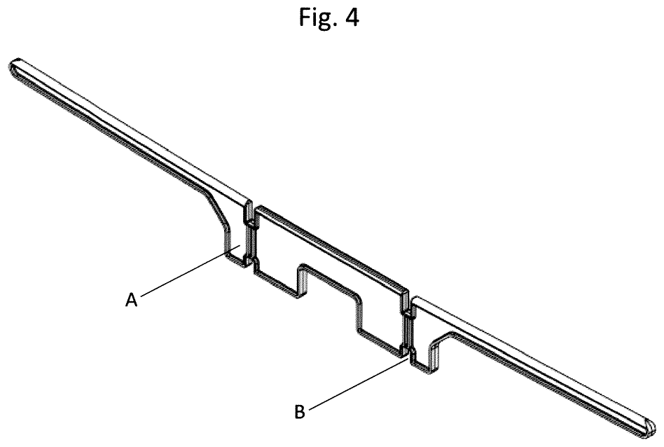

FIG. 4 Is a depiction of an angled view of one arm.
A is Arm;
B is Notch;

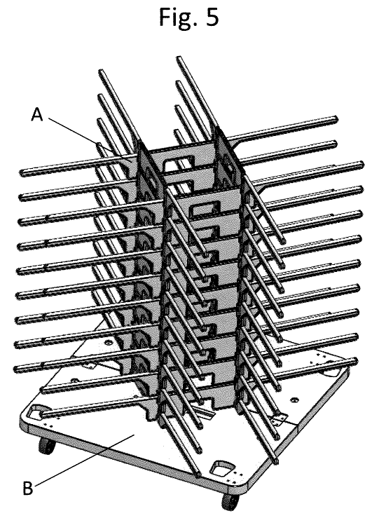

FIG. 5 Is a depiction of an overhead angled view of the assembled Spray Stack attached to its base.
A is Arm;
B is Base;

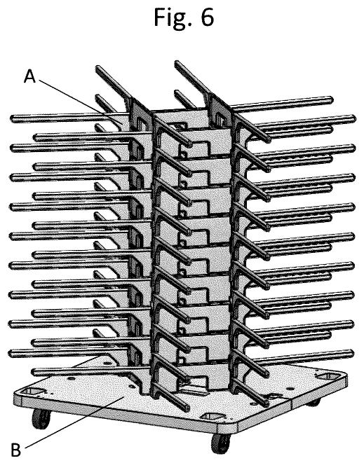

FIG. 6 Is a depiction of a less angled view of the assembled Spray Stack attached to its base.
A is Arm;
B is Base;

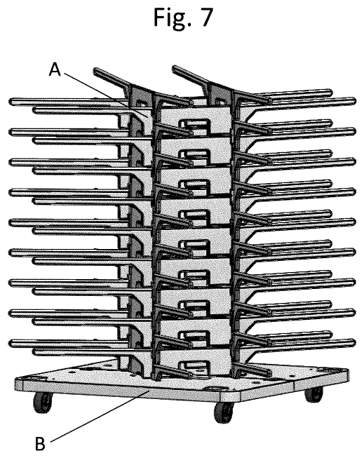

FIG. 7. Is a depiction of a slightly angled view of the assembled Spray Stack attached to its base.
A is Arm
B is Base

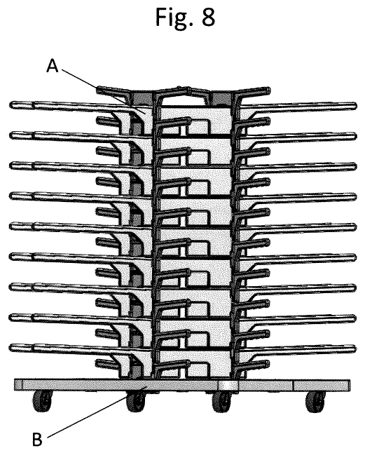

FIG. 8 Is a depiction of a straight-on view of the assembled Spray Stack.
A is Arm;
B is Base;

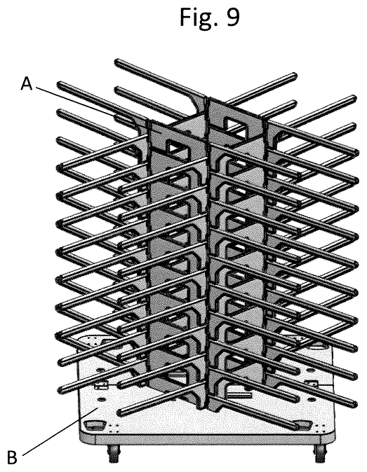

FIG. 9 Is a depiction of a different angled view of the assembled Spray Stack attached to its base.
A is Arm;
B is Base;

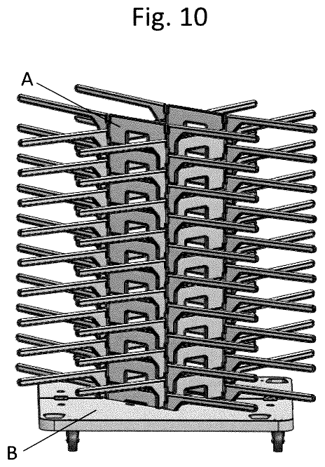

FIG. 10 Is a depiction of a different slightly angled view of the assembled Spray Stack attached to its base.
A is Arm;
B is Base;

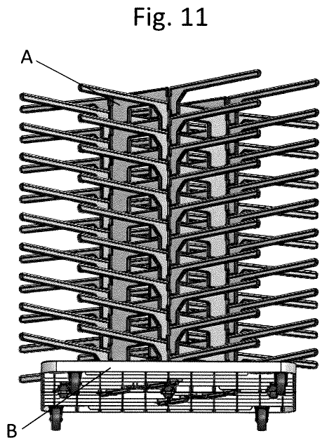

FIG. 11 Is a depiction of the bottom of the Spray Stack base showing the manner by which the Spray Stack is attached to the base.
A is Arm;
B is Base;

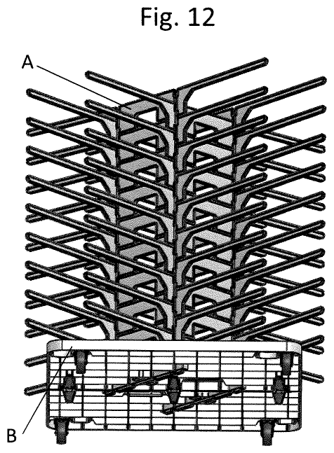

FIG. 12 Is a depiction of a more angled view of the bottom of the Spray Stack base showing the manner by which the Spray Stack is attached to the base.
A is Arm;
B is Base

1. The invention is a rack comprised of levels of notched, interlocking, stacking arms, with two parallel arms per level. Each level's arms are perpendicular to the arms on the level above and below. The lowest level arms insert into a wheeled base without hardware. The levels are created by the arms being stacked upon each other and which interlock without hardware.
